(19) United States
(12) Patent Application Publication
(10) Pub. No.: US 2018/0357580 A1
(43) Pub. Date: Dec. 13, 2018

(54) VEHICLE DRIVER WORKLOAD MANAGEMENT

(71) Applicants: Ford Global Technologies, LLC, Dearborn, MI (US); The Regents of the University of Michigan, Ann Arbor, MI (US)

(72) Inventors: Devinder Singh Kochhar, Ann Arbor, MI (US); Yi Murphey, Ann Arbor, MI (US)

(73) Assignees: Ford Global Technologies, LLC, Dearborn, MI (US); The Regents of the University of Michigan, Ann Arbor, MI (US)

(21) Appl. No.: 15/618,416

(22) Filed: Jun. 9, 2017

(51) Int. Cl. G06Q 10/06

(52) U.S. Cl. CPC G06Q 10/0633

(57) ABSTRACT

A computer includes a processor that is programmed to receive data including a current user biometric data and vehicle operating data. The processor is programmed to determine a user workload value based on the received data and a workload determination classifier that is based on received data including workload values collected from a plurality of tests of test users driving along one or more routes. The processor is programmed to cause an action in the vehicle according to the determined workload.

### BACKGROUND

Vehicle drivers often engage in activities such as talking, texting, interacting with in-vehicle devices, etc., that increase a mental workload of the vehicle driver. Attention to vehicle operation including steering, accelerating, and braking, etc., and the ability to process information related to the vehicle operation may be reduced because of high mental workload levels of the vehicle driver. Vehicle users engaged in such activities that are secondary to safe operation of the vehicle often believe their activities are safe because the vehicle user perceives his or her mental workload to be within a limit that is acceptable to him or her. A reduced attention of the vehicle user and/or the ability of the vehicle driver to process information may degrade a driver's control of the vehicle. Thus, it would be advantageous to provide a solution to the problem that current vehicles lack means to measure user workload, and hence lack means to actuate preventative and/or safety mechanisms based on a user's workload.

### BRIEF DESCRIPTION OF THE DRAWINGS

FIG. 1 is a diagram of an example vehicle and components thereof.

FIG. 2 is a flowchart of an exemplary process for identifying workload determination classifier(s).

FIG. 3 is a flowchart of an exemplary process for determining user workload based on identified classifier(s).

### DETAILED DESCRIPTION

### Introduction

Disclosed herein is a computer including a processor that is programmed to receive data including a current user biometric data and vehicle operating data. The processor is programmed to determine a user workload value based on the received data and a workload determination classifier that is based on received data including workload values collected from a plurality of tests of test users driving along one or more routes. The processor is programmed to cause an action in the vehicle according to the determined workload.

The received data may further include test user biometric data associated with each of the test users driving along the one or more routes.

The current user biometric data may include at least one of a heart rate, respiration rate, galvanic skin response, acceleration magnitude, and voltage waveform of heart beat.

The vehicle operating data may include at least one of a speed, location coordinates, longitudinal acceleration, lateral acceleration, direction of movement.

The processor may be further programmed to receive environmental data and to determine the workload value further based on the environmental data, wherein the environmental data include at least one of traffic data, weather data, and map data.

The vehicle sensor data may include turning, lane changing, merging to another road, and crossing an intersection.

The processor may be further programmed to calculate statistical features of the received data, determine one or more statistical features that correlate with the workload based on the received data, and determine the workload classifier based at least on the determined one or more statistical features that correlate with the workload value and the determined workload values.

The processor may be further programmed to determine the one or more statistical features that correlate with the workload value based on a feature dimension reduction technique.

The processor may be further programmed to determine the statistical features by determining a sliding time interval and associating the determined statistical features with the sliding time interval.

The processor may be further programmed to determine a performance value for the identified classifier and determine whether the determined performance value exceeds a minimum performance threshold.

Further disclosed herein is a method that includes receiving data including a current user biometric data and vehicle operating data, and determining a user workload value based on the received data and a workload determination classifier that is based on received data including workload values collected from a plurality of tests of test users driving along one or more routes. The method includes causing an action in the vehicle according to the determined workload.

The received data may further include test user biometric data associated with each of the test users driving along the one or more routes.

The current user biometric data may include at least one of a heart rate, respiration rate, galvanic skin response, acceleration magnitude, and voltage waveform of heart beat.

The vehicle operating data may include at least one of a speed, location coordinates, longitudinal acceleration, lateral acceleration, direction of movement.

The method may further include receiving environmental data and determining the workload value further based on the environmental data, wherein the environmental data include at least one of traffic data, weather data, and map data.

The vehicle sensor data may include turning, lane changing, merging to another road, and crossing an intersection.

The method may further include calculating statistical features of the received data, determining one or more statistical features that correlate with the workload based on the received data, and determining the workload classifier based at least on the determined one or more statistical features that correlate with the workload value and the determined workload values.

The method may further include determining the one or more statistical features that correlate with the workload value based on a feature dimension reduction technique.

The method may further include determining the statistical features by determining a sliding time interval and associating the determined statistical features with the sliding time interval.

The method may further include determining a performance value for the identified classifier and determining whether the determined performance value exceeds a minimum performance threshold.

Further disclosed is a computing device programmed to execute the any of the above method steps. Yet further disclosed is a vehicle comprising the computing device.

Yet further disclosed is a computer program product, comprising a computer readable medium storing instructions executable by a computer processor, to execute any of the above method steps.

### Exemplary System Elements

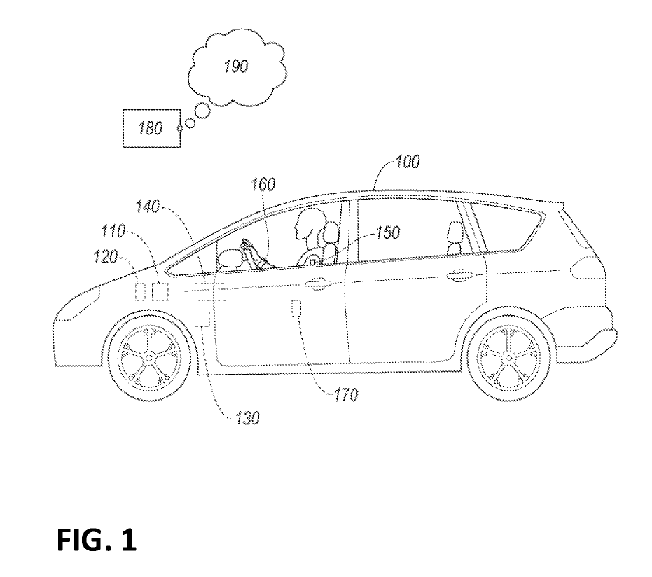

FIG. 1 illustrates an example vehicle 100. The vehicle 100 may be powered in a variety of known ways, e.g., with an internal combustion engine, electric motor, etc. Although illustrated as a passenger car, the vehicle 100 may be another kind of powered (e.g., electric and/or internal combustion engine) vehicle such as a car, a truck, a sport utility vehicle, a crossover vehicle, a van, a minivan, etc. The vehicle 100 may include a computer 110, actuator(s) 120, sensor(s) 130, and a human machine interface (HMI 140). In some examples, as discussed below, the vehicle is an autonomous vehicle configured to operate in an autonomous (e.g., driverless) mode, a semi-autonomous mode, and/or a non-autonomous mode.

The computer 110 includes a processor and a memory such as are known. The memory includes one or more forms of computer-readable media, and stores instructions executable by the computer 110 for performing various operations, including as disclosed herein.

The computer 110 may include programming to operate one or more systems of the vehicle 100, e.g., land vehicle brakes, propulsion (e.g., one or more of an internal combustion engine, electric motor, etc.), steering, climate control, interior and/or exterior lights, etc. The computer 110 may operate the vehicle 100 in an autonomous mode, a semi-autonomous mode, or a non-autonomous mode. For purposes of this disclosure, an autonomous mode is defined as one in which each of vehicle propulsion, braking, and steering are controlled by the computer 110; in a semi-autonomous mode the computer controls one or two of vehicle propulsion, braking, and steering; in a non-autonomous mode, a human operator controls the vehicle propulsion, braking, and steering.

The computer 110 may include or be communicatively coupled to, e.g., via a communications bus of the vehicle 100 as described further below, more than one processor, e.g., controllers or the like included in the vehicle 100 for monitoring and/or controlling various controllers of the vehicle 100, e.g., a powertrain controller, a brake controller, a steering controller, etc. The computer 110 is generally arranged for communications on a communication network of the vehicle 100, which can include a bus in the vehicle 100 such as a controller area network (CAN) or the like, and/or other wired and/or wireless mechanisms.

Via the communication network of the vehicle 100, the computer 110 may transmit messages to various devices in the vehicle 100 and/or receive messages from the various devices, e.g., an actuator 120, an HMI 140, etc. Alternatively or additionally, in cases where the computer 110 actually comprises multiple devices, the vehicle communication network may be used for communications between devices represented as the computer 110 in this disclosure.

The actuators 120 of the vehicle 100 are implemented via circuits, chips, or other electronic and/or mechanical components that can actuate various vehicle subsystems in accordance with appropriate control signals, as is known. The actuators 120 may be used to control vehicle systems such as braking, acceleration, and/or steering of the vehicles 100.

In addition, the computer 110 may be configured for communicating through a vehicle-to-infrastructure (V-to-I) interface with other vehicles, and/or a remote computer 180 via a network 190. The network 190 represents one or more mechanisms by which the computer 110 and the remote computer 180 may communicate with each other, and may be one or more of various wired or wireless communication mechanisms, including any desired combination of wired (e.g., cable and fiber) and/or wireless (e.g., cellular, wireless, satellite, microwave and radio frequency) communication mechanisms and any desired network topology (or topologies when multiple communication mechanisms are utilized). Exemplary communication networks include wireless communication networks (e.g., using one or more of cellular, Bluetooth, IEEE 802.11, etc.), dedicated short range communications (DSRC), local area networks (LAN) and/or wide area networks (WAN), including the Internet, providing data communication services.

The HMI 140 may be configured to receive user input, e.g., during operation of the vehicle 100. Moreover, an HMI 140 may be configured to present information to the user. Thus, the HMI 140 is typically located in a passenger cabin of the vehicle 100. For example, the HMI 140 may provide information to the user including an indication of vehicle 100 user impairment, an activation of vehicle 100 autonomous mode based on vehicle 100 user impairment, etc.

The sensors 130 may include a variety of devices known to provide operating data to the computer 110. In the context of this disclosure, vehicle 101 “operating data” means data received from sensors 130 and/or electronic control units (ECUs) in the vehicle describing a state of the vehicle 101 (e.g., speed, a transmission state, etc.) a component thereof, and/or data sensed from a vehicle 101 environment while the vehicle 101 is operating. For example, the sensors 130 may include Light Detection And Ranging (LIDAR) sensor(s) 130 disposed on a top, a pillar, etc. of the vehicle 100 that provide relative locations, sizes, and shapes of other vehicles and/or objects surrounding the vehicle 100. As another example, one or more radar sensors 130 fixed to vehicle 100 bumpers may provide locations of the second vehicles 101 travelling in front, side, and/or rear of the vehicle 100, relative to the location of the vehicle 100. The sensors 130 may further alternatively or additionally include camera sensor(s) 130, e.g. front view, side view, etc., providing images from an area around the vehicle 100. For example, the computer 110 may be programmed to receive operating data including image data from the camera sensor(s) 130 and to implement image processing techniques to detect lane markings, traffic signs, and/or other objects such as other vehicles. As another example, the computer 110 may be programmed to determine whether a distance to another vehicle is less than a predetermined threshold, whether an unexpected lane departure occurred, etc. The computer 110 may receive operating data including object data from, e.g., camera sensor 130, and operate the vehicle 100 in an autonomous and/or semi-autonomous mode based at least in part on the received object data.

The sensors 130 may include location sensors 130 that utilize the Global Positioning System (GPS), sometimes referred to as GPS sensors 130. Based on data received from a GPS sensor 130, the computer 110 may determine geographical location coordinates, movement direction, speed, etc., of the vehicle 100. The sensors 130 may include acceleration sensors 130 providing longitudinal and/or lateral acceleration of the vehicle 100.

The sensors 130 may include a camera sensor 130 with a field of view including a vehicle 100 interior. For example, the field of view of the camera sensor 130 may include a vehicle 100 user. The computer 110 may be programmed to determine user biometric data such as a posture, face direction, pupil diameter, pupillary response rate, etc. of the user based on image data received from the camera sensor 130. The computer 110 may be programmed to receive biometric data from other sensors 130, e.g., temperature sensor 130 included in a user seat, microphone, etc. Additionally, vehicle 100 user devices may operate as sensor 130. For example, a wearable device 160 may provide user biometric data such as user heart rate. A transdermal patch 150 that is typically used for drug delivery may include sensors to determine various biometric data such as blood content of a chemical substance, etc., As another example, an implantable biomedical device such as a miniaturized robot implanted in user's body (e.g. inside blood vessels), a device implanted under the skin, etc., may provide biometric data of the user.

Biometric data, in the context of present disclosure, is data about a physical state or attribute of a user and may include user physiological markers such as a posture, eye status (e.g., open, close, etc.), pupil response rate, heart rate, voltage waveform of heart beat, respiration rate, blood pressure value, reaction time, skin temperature, galvanic skin response, muscle tremors, peak acceleration magnitude of user body, etc. The term “physiological marker” (used herein interchangeably with the terms “biological marker” and “biomarker”) herein refers to a measurable indicator of some biological state or condition. e.g., a pulse rate, a respiration rate, a body temperature, pupil dilation, a concentration of a chemical in the bloodstream, etc.

A user posture may include location coordinates of user hands, curvature of a user spine including neck curvature, angle of user spine relative to vehicle 100 floor, etc. A user's face direction may include three-dimensional coordinates of a line of sight extending from the user face.

The biometric data may include vehicle 100 user personal information or profile such as age, height, weight, etc. The computer 110 may be programmed to receive user information from the remote computer 180, e.g., via the communication network 190.

Drivers often engage in secondary in-vehicle activities that are not related to vehicle control. “Secondary activity,” in the present context, means an activity that does not provide input to control any of acceleration, braking, or steering, and that therefore is not required for safe operation of the vehicle 100. Operating one or more of vehicle 100 steering, acceleration, and braking, in contrast, are primary activities. Examples of secondary activities may include interacting with vehicle 100 HMI 140, e.g., operating a climate control to, e.g., change vehicle 100 cabin temperature, eating or drinking, operating a portable electronic device, e.g., a smartphone or the like, e.g., to place a call or send a text message, etc. A user's attention to primary activities and the ability to process information related to primary activities (e.g., estimating time-to-collision with other vehicles and avoiding collisions) may be reduced by high workload levels of a vehicle user due to secondary activities.

The computer 110 is programmed to receive data including user biometric data and vehicle 100 operating data. The computer 110 is programmed to determine a user workload value based on the received data and a workload determination classifier that is based on received data including workload values collected from a plurality of tests of test users driving along one or more routes. The computer 110 is further programmed to cause an action in the vehicle 100 according to the determined workload.

The term “workload”, in the present context, means a measure or value of mental activities of user's brain including all primary and secondary activities, as described above. The workload may vary over time, e.g., as the activities of a vehicle 100 user change over time. In one example, a workload value may be one of a plurality of discrete levels, such as a “low,” “medium,” and “high” workload. In another example, the workload may be defined as a numerical value between 0 (zero) and 10. For example, the computer 110 may be programmed to cause an action when a determined workload exceeds a workload threshold, e.g., 7. The computer 110 may be programmed to cause an action by outing a message via the vehicle 100 HMI 140, preventing an activation of a vehicle 100 non-autonomous mode, etc.

The computer 110 is programmed to receive user biometric data including physiological markers such as a heart rate, galvanic skin response, etc., as discussed above.

The computer 110 is programmed to receive the vehicle 100 operating data, e.g., speed, location coordinates, longitudinal acceleration, lateral acceleration, direction of movement, etc. The computer 110 may be programmed to receive the vehicle 100 operating data from the vehicle 100 sensors 130, e.g., a GPS sensor 130, acceleration sensor 130, etc. Additionally, the computer 110 may be programmed to receive environmental data and to determine the workload value further based on the environmental data. The environmental data may include traffic data, weather data, and map data. For example, traffic data may be correlated to workload, e.g., a higher traffic may cause more workload. In another example, the weather data, e.g., inclement weather conditions, may increase vehicle 100 user workload. The map data may be correlated to the workload, e.g., crossing a complex multi-level road intersection may cause more workload.

The computer 110 may be programmed to receive vehicle 100 operating data including traffic events such as turning, lane changing, merging to another road, and crossing an intersection. Traffic events may lead to an increase of workload of the vehicle 100 user. For example, during a merge to a freeway, a user workload may increase because of necessary adjustment of vehicle 100 speed and lane changing to avoid a collision with other vehicles on the freeway.

A “workload classifier” or in short a “classifier,” as that term is used herein, may include an algorithm that outputs a workload value, e.g., a set of one or more rules including logical and/or mathematical operations based at least on the received data. For example, a classifier may output a numerical value for user workload based on inputs including the biometric data and the vehicle 100 operating data.

Various techniques can be used to generate a workload classifier. In one example, ground truth data is collected to create classifier(s). Ground truth data, in the present context, means reference or baseline data including received biometric data, vehicle 100 operating data, etc., in addition to a reference or baseline workload determined for a vehicle 100 user. The vehicle 100 may be driven by different test users on multiple predetermined routes. A test user that drives the vehicle 100 and/or a second user, e.g., a passenger, in the vehicle 100 may determine a reference workload of the vehicle 100 user, e.g., periodically every 10 seconds, based on observing the vehicle 100, road, environment, user activities, etc. For example, a vehicle 100 passenger may log a vehicle 100 user workload every 10 seconds, e.g., by entering a workload value between 0 and 10 in an HMI 140 device, e.g., typing via a keyboard, audio recording, etc. To collect workloads for a diversity of routes, the predetermined routes may include routes covering one or more of a freeway, highways, narrow lanes, a rural area, an urban area, mountainous or hilly terrain, etc. To include workloads for a diversity of driving conditions, the routes may be driven in different traffic and/or other driving conditions, e.g., congested rush hours, night, day light, inclement weather conditions, etc. To include a diversity of test users, individuals with various biological and/or demographic profiles, e.g., different age, gender, driving experience, etc., can be test users. The computer 110 may be programmed to receive data including test user biometric data associated with each of the test users driving along the one or more routes.

A computer, e.g., the remote computer 180, etc., can be programmed to receive the ground truth data, e.g., the vehicle 100 operating data, the biometric data, etc., and the determined reference workload values, synchronized with the biometric and vehicle 100 operating data. “Synchronized” means that ground truth data at any given time included in a measurement corresponds to data received at the respective time from the vehicle 100 operating data and user biometric data. For example, the ground truth data may include a current vehicle 100 speed, acceleration, etc., a current user blood pressure, galvanic skin response, pupillary response, user face direction, etc. synchronized with the received reference workload from the vehicle 100 user and/or passenger.

The remote computer 180, the vehicle 100 computer 110, or any combination thereof, can then calculate statistical features of the received data. Statistical features may include any of maximum, mean, minimum, median value, standard deviation, interquartile range, energy, zero crossing rate, Skewness, Kurtosis, root mean square, etc., of the received data including the biometric data, the vehicle 100 operating data, etc.

In one example, the remote computer 180 (or alternatively or additionally the computer 110) may be programmed to calculate the statistical features by determining time intervals and calculating the statistical features for each respective time interval. For example, the remote computer 180 may be programmed to determine 5 second time intervals based on a 530-second-long test drive. Additionally, the remote computer 180 may determine 106 time intervals, each 5 second long. The remote computer 180 may be programmed to receive every 5 seconds a determined reference workload value from a test user and/or a vehicle 100 passenger, and associate the received reference workload to the respective time interval (i.e., a time interval at which the reference workload value was received.) The remote computer 180 may be programmed to calculate the statistical features of each time interval and associate the calculated statistical features to the respective time interval. Thus, the remote computer 180 may store statistical features and reference workload values corresponding to each time interval in a computer 110 memory. In one example, the data may be stored in a vector form, e.g., a matrix with dimensions 106×13. Each row may represent one time interval; 12 calculated statistical features, e.g., minimum, maximum, etc., and the reference workload associated with the respective time interval. 106 rows include data for 106 time intervals (each 5 seconds) of the example test drive of 530 seconds. The time interval may be referred to as a sliding time interval, as the time interval moves along the collected data, e.g., 0-5 sec (second), 5-10 sec, 10-15 sec, etc.

The remote computer 180 is programmed to identify the classifier(s) based on data classification techniques. The remote computer 180 may be programmed to determine the classifier based on calculated features and associated reference workloads, e.g., the stored matrix. However, considering a high-dimension matrix in identifying the classifier(s) may lead to a high computational cost, i.e., consumption of processing resources. A high computation cost herein could be a long execution time of the classifier in a computer such as the computer 110. Therefore, it may be desirable to identify the classifiers based on matrices (statistical features and reference workloads) with lower dimensions.

The remote computer 180 may be programmed to calculate statistical features of the received data, and determine one or more statistical features that correlate with the workload based on the received data. The remote computer 180 may then determine the workload classifier(s) based at least on the determined statistical feature(s) that correlate with the workload value and the determined workload values. For example, rather than using a 106×13 matrix, a reduced matrix such as a 106×6 matrix can be used.

In one example, feature reduction techniques such as feature dimension reduction may be used to reduce a number of calculated features that are considered for identifying the classifiers. In other words, a reduced set of features among the calculated features is selected to use for identifying the classifier(s). For example, Principal Components Analysis (PCA) is a statistical procedure that uses an orthogonal transformation to convert a set of observations of possibly correlated variables into a set of values of linearly uncorrelated variables, called principal components. The reduced feature sets can be obtained by selecting the primary components only while abandoning other components, depending on the ratio of feature variance desired to retain.

The remote computer 180 may be further programmed to define the classifiers using a mathematical method such as support vector machine (SVM) based on the reduced set of statistical features. Although SVM is typically used for bi-class classification, e.g., a hyperplane separating data into two groups, multiple classification steps may be used to define a multi-dimensional classifier for workload determination, e.g., a classifier that can determine workloads “low”, medium”, and “high.” In one example, three classifiers may be defined each separating two workload levels, e.g., a first classifier that determines whether the workload is “low” or “high”, a second classifier that determines whether the workload is “low” or “medium”, and a third classifier that determines whether the workload is “medium” or “high.”

The computer 110 may be programmed to determine the workload by inputting the received data including the vehicle 100 operating data, the biometric data, etc., to each of the classifiers and then determine the workload based on determining which workload level has higher votes, i.e., more classifiers output that value. For example, the computer 110 may determine that the workload is “medium” when the first, second, and third classifiers determine workload levels of “high,” “medium,” “medium.” The computer 110 may determine that the workload is “low” when the first, second, and third classifiers determine workload levels of “low,” “low,” medium.” The computer 110 may determine that the workload is “high” when the first, second, and third classifiers determine workload levels of “high,” “medium,” high.”

Additionally or alternatively, other techniques may be used to generate a workload determination classifier. For example, the remote computer 180 may be programmed to generate a neural network-based model to identify the workload value. A neural network may have inputs including the statistical features of received data and may output a workload value based on the received input data.

Additionally or alternatively, the remote computer 180 may be programmed to determine a performance value of the identified classifier based on the ground truth data. The performance value, as the term is defined here, is a ratio of correctly determined workload values to total number of collected reference workload values. In one example, the computer 110 may be programmed to determine the workload based on the received data and determine the performance value based on the determined workload and the reference workload. For example, a performance value of 50% means half of the determined workload values match the reference workload.

### Processing

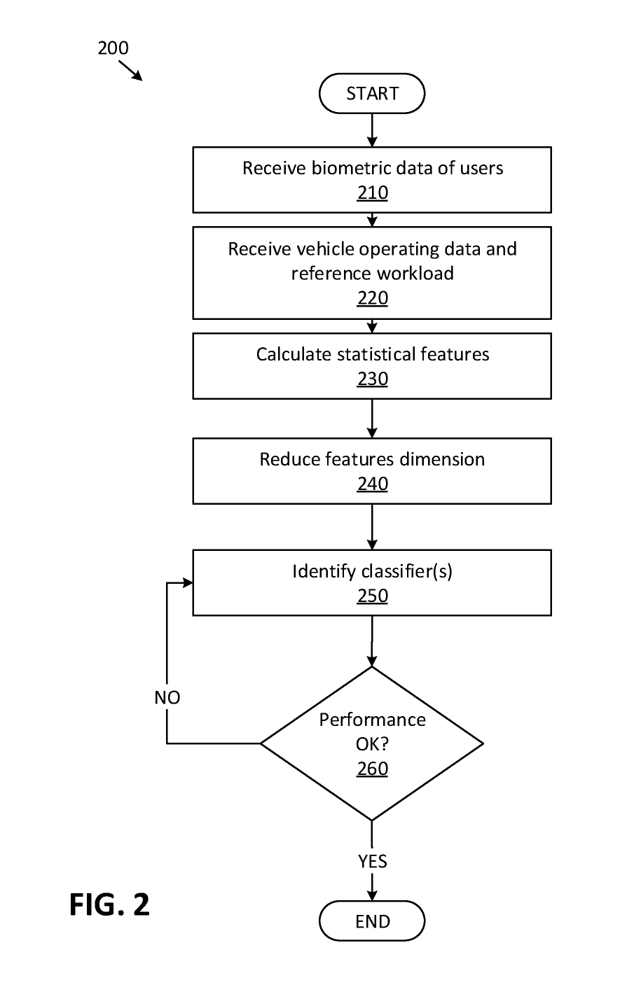

FIG. 2 is a flowchart of an exemplary process 200 for identifying workload determination classifier(s). For example, the remote computer 180, the vehicle computer 110, or a combination thereof, may be programmed to execute blocks of the process 200.

The process 200 begins in a block 210, in which the remote computer 180 receives biometric data of vehicle 100 users. For example, the biometric data may include personal information of users such as age, gender, number of years of experience in driving, etc. from a remote computer. Additionally, the biometric data may include physiological markers such as heart rate, galvanic skin response, pupillary response, etc., from the wearable device 160, the sensors included in the transdermal patch 150, etc.

Next, in a block 220, the remote computer 180 receives vehicle 100 operating data and the reference workload. For example, the remote computer 180 may be programmed to receive vehicle 100 speed, acceleration, location coordinates, etc. from the vehicle 100 sensors 130. The computer 180 may be programmed to receive the reference workload values from, e.g., an HMI 140 of the vehicle 100. Additionally, the remote computer 180 may be programmed to receive environmental data such as weather data, traffic data, etc. Additionally, the remote computer 180 may be programmed to receive traffic event data such as lane change, crossing intersection, merging, etc.

Next, in a block 230, the remote computer 180 calculates statistical features, e.g., minimum, maximum, mean, average, energy, zero crossing rate, etc., of the received data. The remote computer 180 may be programmed to identify a sliding time interval, e.g., 5 seconds, and determine the statistical features for a respective time interval.

Next, in a block 240, the remote computer 180 reduces feature dimensions. For example, the remote computer 180 may be programmed to determine one or more statistical features that correlate with the workload based on the received data, e.g., based on feature reduction techniques.

Next, in a block 250, the remote computer 180 identifies the classifier(s) for determining user workload. In one example, an identified classifier may include a mathematical and/or logical operation that takes the received data such a biometric data, vehicle 100 operating data, etc., as input and outputs a workload value.

Next, in a decision block 260, the remote computer 180 determines whether a performance of the identified classifier is acceptable. The remote computer 180 may be programmed to determine a performance value of the identified classifiers(s) by determining the workload associated with ground truth data based on the identified classifier(s), and comparing the determined workload to the reference workload. If the remote computer 180 determines that the performance value exceeds a minimum performance threshold, then the process 200 ends (or returns to the block 210, although not shown in FIG. 2); otherwise the process 200 returns to the block 250.

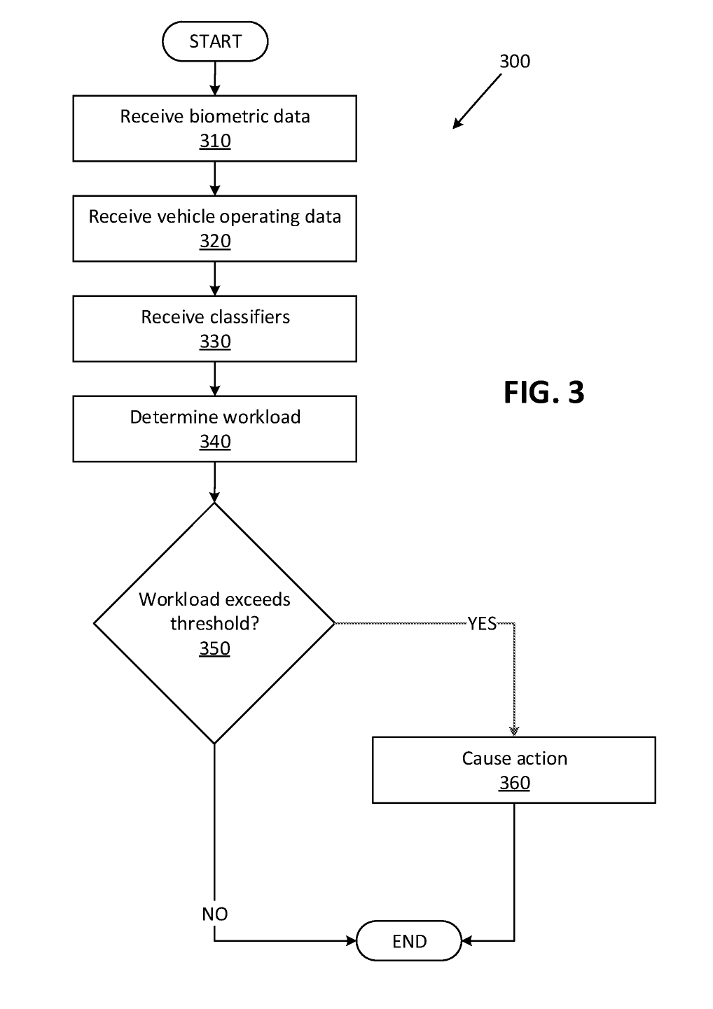

FIG. 3 is a flowchart of an exemplary process 300 for determining and acting on a current user workload based on one or more classifiers generated as described above. For example, the computer 110 may be programmed to execute blocks of the process 300.

The process 300 begins in a block 310, in which the computer 110 receives biometric data from a user device 160, a sensor in a user transdermal patch 150, and/or the remote computer 180.

Next, in a block 320, the computer 110 receives vehicle 100 operating data, e.g., vehicle 100 speed, acceleration, etc. Additionally, the computer 110 may be programmed to receive traffic data, environmental data, etc.

Next, in a block 330, the computer 110 receives one or more classifier, e.g., stored in a computer 110 memory.

Next, in a block 340, the computer 110 determines a current user workload value based on the received data and the classifier(s). For example, the computer 110 may determine a workload level including “low,” “medium,” and “high.”

Next, in a decision block 350, the computer 110 determines whether the determined workload exceeds a predetermined threshold, e.g., a “medium” level. If the computer 110 determines that the computer 110 exceeds the predetermined threshold, the process 300 proceeds to a block 360; otherwise the process 300 ends, or alternatively returns to the block 310, although not show in FIG. 3.

In the block 360, the computer 110 causes an action, i.e., actuation of at least one vehicle 100 component. For example, the computer 110 may activate a vehicle 100 autonomous mode upon determining that the workload exceeds a “medium” workload level, and thereby provide instructions to actuate vehicle 100 powertrain, steering, and/or braking. Additionally or alternatively, the computer 110 may be programmed to prevent an activation of a vehicle 100 non-autonomous mode upon determining that the workload exceeds a “low” level. Additionally or alternatively, the computer 110 may be programmed to actuate a vehicle 100 HMI 140 to output a visual, textual, and/or audio message to the vehicle 100 user. Following the block 360, the process 300 ends, or alternatively returns to the block 310, although not shown in FIG. 3.

The article “a” modifying a noun should be understood as meaning one or more unless stated otherwise, or context requires otherwise. The phrase “based on” encompasses being partly or entirely based on.

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH, an EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A computer, comprising a processor programmed to:
receive data including a current user biometric data and vehicle operating data;
determine a user workload value based on the received data and a workload determination classifier that is based on received data including workload values collected from a plurality of tests of test users driving along one or more routes; and
cause an action in the vehicle according to the determined workload.

2. The computer of claim 1, wherein the received data further include test user biometric data associated with each of the test users driving along the one or more routes.

3. The computer of claim 1, wherein the current user biometric data include at least one of a heart rate, respiration rate, galvanic skin response, acceleration magnitude, and voltage waveform of heart beat.

4. The computer of claim 1, wherein the vehicle operating data include at least one of a speed, location coordinates, longitudinal acceleration, lateral acceleration, direction of movement.

5. The computer of claim 1, wherein the processor is further programmed to receive environmental data and to determine the workload value further based on the environmental data, wherein the environmental data include at least one of traffic data, weather data, and map data.

6. The computer of claim 1, wherein the vehicle sensor data include turning, lane changing, merging to another road, and crossing an intersection.

7. The computer of claim 1, wherein the processor is further programmed to:
calculate statistical features of the received data;
determine one or more statistical features that correlate with the workload based on the received data; and
determine the workload classifier based at least on the determined one or more statistical features that correlate with the workload value and the determined workload values.

8. The computer of claim 7, wherein the processor is further programmed to determine the one or more statistical features that correlate with the workload value based on a feature dimension reduction technique.

9. The computer of claim 7, wherein the processor is further programmed to determine the statistical features by determining a sliding time interval and associating the determined statistical features with the sliding time interval.

10. The computer of claim 1, wherein the processor is further programmed to determine a performance value for the identified classifier and determine whether the determined performance value exceeds a minimum performance threshold.

11. A method, comprising:
receiving data including a current user biometric data and vehicle operating data;
determining a user workload value based on the received data and a workload determination classifier that is based on received data including workload values collected from a plurality of tests of test users driving along one or more routes; and
causing an action in the vehicle according to the determined workload.

12. The method of claim 11, wherein the received data further include test user biometric data associated with each of the test users driving along the one or more routes.

13. The method of claim 11, wherein the current user biometric data include at least one of a heart rate, respiration rate, galvanic skin response, acceleration magnitude, and voltage waveform of heart beat.

14. The method of claim 11, wherein the vehicle operating data include at least one of a speed, location coordinates, longitudinal acceleration, lateral acceleration, direction of movement.

15. The method of claim 11, further comprising receiving environmental data and determining the workload value further based on the environmental data, wherein the environmental data include at least one of traffic data, weather data, and map data.

16. The method of claim 11, wherein the vehicle sensor data include turning, lane changing, merging to another road, and crossing an intersection.

17. The method of claim 11, further comprising:
calculating statistical features of the received data;
determining one or more statistical features that correlate with the workload based on the received data; and
determining the workload classifier based at least on the determined one or more statistical features that correlate with the workload value and the determined workload values.

18. The method of claim 17, further comprising determining the one or more statistical features that correlate with the workload value based on a feature dimension reduction technique.

19. The method of claim 17, further comprising determining the statistical features by determining a sliding time interval and associating the determined statistical features with the sliding time interval.

20. The method of claim 11, further comprising determining a performance value for the identified classifier and determining whether the determined performance value exceeds a minimum performance threshold.
